(19) United States
(12) Patent Application Publication
(10) Pub. No.: US 2026/0046525 A1
(43) Pub. Date: Feb. 12, 2026

(54) VEHICLE VIDEO RECORDING DEVICE AND METHOD OF CONTROLLING THE SAME

(71) Applicants: Hyundai Motor Company, Seoul (KR); Kia Corporation, Seoul (KR)

(72) Inventor: Sang Woo CHUN, Hwaseong-si (KR)

(73) Assignees: Hyundai Motor Company, Seoul (KR); Kia Corporation, Seoul (KR)

(21) Appl. No.: 19/171,716

(22) Filed: Apr. 7, 2025

(30) Foreign Application Priority Data
Aug. 12, 2024 (KR) 10-2024-0107816

(51) Int. Cl. H04N 23/74; B60Q 1/08; B60Q 1/24; F21S 41/60; H04N 5/77; H04N 23/71

(52) U.S. Cl. CPC H04N 23/74; B60Q 1/085; B60Q 1/249; F21S 41/60; H04N 5/77; H04N 23/71

(57) ABSTRACT

A method for controlling a vehicle video recording device includes a step of transmitting a command to a lamp controller to operate a lamp in a case where an impact is predicted or an impact is sensed based on information sensed from a motion sensor and/or an impact sensor.

### CROSS-REFERENCE TO RELATED APPLICATION

The present application claims priority to Korean Patent Application No. 10-2024-0107816, filed on Aug. 12, 2024, the entire contents of which is incorporated herein for all purposes by this reference.

### BACKGROUND OF THE PRESENT DISCLOSURE

### Field of the Present Disclosure

The present disclosure relates to a vehicle video recording device and a method for controlling the vehicle video recording device.

### Description of Related Art

A vehicle video recording device is, for example, a device of recording a video on a traveling or parked state of a vehicle.

The vehicle video recording device may be generally referred to as a traveling video recording device because the device is mainly aimed to obtain a video on an accident during traveling.

To obtain a video, the vehicle video recording device basically includes a controller, a memory for storing a video, and a camera for imaging a video.

The vehicle video recording device generally stores a video of a surrounding of a vehicle during traveling along with vehicle traveling data at the time, and records a video in accordance with a pre-input setting when a set event occurrence is sensed even in a parked state.

At the early stage, the vehicle video recording device was a so-called black box, which was mounted externally. However, recently, the vehicle video recording device has been provided as a built-in device, which is already embedded in a vehicle before the delivery of the vehicle.

Such a built-in camera is more advantageous than an external one in that the built-in camera can access to traveling data of a host vehicle and may be connected to other controllers, and therefore it is prospected that use of the built-in camera will be gradually increased.

The vehicle video recording device carries out regular recording and event recording during traveling or in a parked state, and can allow system setting and stored video checking, interworked with audio video navigation (AVN).

However, the current video recording device (so-called black box) including after-market products records a video in a parked state regardless of the condition, whether it is during day, during night, or under a low luminance condition, and in the instant case, there may be a case where it is difficult to grasp information on a recorded video due to image degradation caused by light amount shortage. There are many cases where it is impossible to identify a vehicle number plate and identify a surrounding state.

Therefore, there is a demand for development of a vehicle video recording device that can accurately recognize important information on a video recorded during night or in a low luminance environment.

The information included in this Background of the present disclosure is only for enhancement of understanding of the general background of the present disclosure and may not be taken as an acknowledgement or any form of suggestion that this information forms the prior art already known to a person skilled in the art.

### BRIEF SUMMARY

Various aspects of the present disclosure are directed to providing a control method of autonomously generating a light source by predicting an impact or right after an impact, in a case of recording video information by a camera of a vehicle video recording device, diversifying light information input to the camera, and adjusting luminance of a recording environment.

Technical tasks that the present disclosure is to achieve are not limited to the technical tasks described above, and other technical tasks that have not been described will be clearly understood by those having ordinary knowledge in the field of the present disclosure to which the present disclosure belongs, from the description below.

A vehicle video recording device according to an exemplary embodiment of the present disclosure includes a motion sensor configured to detect movement of an external object of the vehicle, an impact sensor configured to detect an impact of the external object on the vehicle, a lamp controller configured to control a lamp of the vehicle, and a controller including a memory storing computer-readable instructions and one or more processors configured to execute the computer-readable instructions, wherein the computer-readable instructions executed by the one or more processors, cause the controller to determine that the impact is predicted or has been sensed based on information from at least one of the motion sensor or the impact sensor, and transmit a first command to the lamp controller for operating the lamp and a second command to the camera for recording.

In at least an exemplary embodiment of the present disclosure, the computer-readable instructions cause the controller to determine that a parking mode is activated and transmit a command to the lamp controller to set an option for entering into an impact-based lamp operation mode, and wherein the option for entering into the impact-based lamp operation mode includes at least one of a regular entry for entering into the impact-based lamp operation mode whenever the parking mode is activated, an environment-based entry for entering into the impact-based lamp operation mode when a set external environmental condition is satisfied, or a light-based entry for entering into the impact-based lamp operation mode when a set external light amount condition is satisfied.

In at least an exemplary embodiment of the present disclosure, the environment-based entry includes entering into the impact-based lamp operation mode based on a determination of whether or not a time when the parking mode of the vehicle is activated is between a sunset time and a sunrise time, or whether or not a condition under which a headlamp of the vehicle is turned by AUTO-ON setting is satisfied.

In at least an exemplary embodiment of the present disclosure, the light-based entry includes entering into the impact-based lamp operation mode based on information on brightness of a recorded video.

In at least an exemplary embodiment of the present disclosure, the computer-readable instructions cause the controller to determine that the impact is predicted based on the external object being predicted to enter into a first area from a second area at a speed faster than or equal to a set speed.

In at least an exemplary embodiment of the present disclosure, the set speed includes a first speed for a front side or a rear side of the vehicle and a second speed for a lateral side of the vehicle.

In at least an exemplary embodiment of the present disclosure, the computer-readable instructions cause the controller to transmit a command to the lamp controller to output a lamp control signal to a lamp of the vehicle located correspondingly to a position or a direction of the impact.

In at least an exemplary embodiment of the present disclosure, the lamp control signal includes a first lamp control signal associated with a headlamp module or a front fog lamp based on the position or the direction of the impact being a front side, a second lamp control signal associated with a turn signal lamp or a lamp in an outsider mirror based on the position or the direction of the impact being a lateral side, a third lamp control signal associated with a rear fog lamp or a tail lamp based on the position or the direction of the impact being a rear side, or a fourth lamp control signal associated with a lamp in an interior of the vehicle based on the movement of the external object being sensed in the interior of the vehicle.

In at least an exemplary embodiment of the present disclosure, the computer-readable instructions cause the controller to command the lamp controller to output a lamp control signal based on a movement path of the external object after the impact, and the lamp control signal includes respective lamp control signals to a plurality of lamps corresponding to an overlapping area.

In at least an exemplary embodiment of the present disclosure, based on the external object being sensed to move in a front direction after the impact, the computer-readable instructions cause the controller to transmit a command to the lamp controller to control a headlamp and/or HBA/AFLS based on a position of the external object.

In at least an exemplary embodiment of the present disclosure, the computer-readable instructions cause the controller to transmit a command to the lamp controller to control the lamp to emit light on the external object that has provided the impact by use of an adaptive driving beam (ADB) control.

Meanwhile, a method of recording a vehicle video according to an exemplary embodiment of the present disclosure includes starting, by a controller, a parking mode of the video recording device, detecting, by a motion sensor, movement of an external object of the vehicle, detecting, by an impact sensor, an impact of the external object on the vehicle, and transmitting, by the controller, a command to a lamp controller to operate a lamp based on the impact being predicted or sensed based on information on the movement or the impact of the external object.

In a method of at least an exemplary embodiment of the present disclosure, the starting of the parking mode includes setting an option for entering into an impact-based lamp operation mode, and setting the option includes at least one of a regular entry for entering into the impact-based lamp operation mode whenever the parking mode is activated, an environment-based entry for entering into the impact-based lamp operation mode when a set external environmental condition is satisfied, or a light-based entry for entering into the impact-based lamp operation mode when a set external light amount condition is satisfied.

In a method of at least an exemplary embodiment of the present disclosure, the environment-based entry includes entering into the impact-based lamp operation mode based on a determination of whether or not a time when the parking mode of the vehicle is activated is between a sunset time and a sunrise time, or whether or not a condition under which a headlamp of the vehicle is turned by AUTO-ON setting is satisfied.

In a method of at least an exemplary embodiment of the present disclosure, the light-based entry includes entering into the impact-based lamp operation mode based on information on brightness of a recorded video.

In at least an exemplary embodiment of the present disclosure, the method may further include determining that the impact is predicted by determining that the external object is predicted to enter into a first area from a second area at a speed faster than or equal to a set speed.

In a method of at least an exemplary embodiment of the present disclosure, the set speed includes a first speed for a front side or a rear side of the vehicle and a second speed for a lateral side of the vehicle.

In a method of at least an exemplary embodiment of the present disclosure, the transmitting of the command to the lamp controller includes transmitting a command to the lamp controller to output a lamp control signal to a lamp of the vehicle located correspondingly to a position or a direction of the impact.

In a method of at least an exemplary embodiment of the present disclosure, the lamp control signal includes a first lamp control signal associated with a headlamp module or a front fog lamp based on the position or the direction of the impact being a front side, a second lamp control signal associated with a turn signal lamp or a lamp in an outsider mirror based on the position or the direction of the impact being a lateral side, a third lamp control signal associated with a rear fog lamp or a tail lamp based on the position or the direction of the impact being a rear side, or a fourth lamp control signal associated with a lamp in an interior of the vehicle based on the movement of the external object being sensed in the interior of the vehicle.

In a method of at least an exemplary embodiment of the present disclosure, the transmitting of the command to the lamp controller includes transmitting a command to output a lamp control signal based on a movement path of the external object after the impact, and wherein the lamp control signal includes respective lamp control signals to a plurality of lamps corresponding to an overlapping area.

According to at least an exemplary embodiment of the present disclosure, in a case where a video recording event occurs under a parked condition, through a control by cooperation between a vehicle video recording device and a vehicle lamp control device integrated in the vehicle, it is possible to improve quality of information on video recording by controlling brightness of the surrounding during night and in a low luminance environment.

According to an exemplary embodiment of the present disclosure, it is possible to realize thereof only by changing a software for the existing video recording device without an additional hardware.

Effects that the present disclosure is to achieve are not limited to the effects described above, and other effects that have not been described will be clearly understood by those having ordinary knowledge in the field of the present disclosure to which the present disclosure belongs, from the description below.

The methods and apparatuses of the present disclosure have other features and advantages which will be apparent from or are set forth in more detail in the accompanying drawings, which are incorporated herein, and the following Detailed Description, which together serve to explain certain principles of the present disclosure.

### BRIEF DESCRIPTION OF THE DRAWINGS

FIG. 1 is a view exemplarily illustrating a vehicle video recording device according to an exemplary embodiment of the present disclosure and a configuration of a vehicle including thereof.

FIG. 2 is a view exemplarily illustrating a process of entering into an impact-based lamp operation mode in a case where a parking mode of a vehicle video recording device according to an exemplary embodiment of the present disclosure starts.

FIG. 3 is a view exemplarily illustrating impact prediction and pre-lamp operation according to an exemplary embodiment of the present disclosure.

FIG. 4 is a flowchart of pre-impact prediction steps according to an exemplary embodiment of the present disclosure.

FIG. 5 is a view of lamp operation according to distinction between motion sensor detecting areas according to an exemplary embodiment of the present disclosure.

FIG. 6 is a view exemplarily illustrating criteria on speed setting of an external object in a case of pre-impact prediction according to an exemplary embodiment of the present disclosure.

FIG. 7 is a flowchart of pre-lamp operation steps according to an exemplary embodiment of the present disclosure.

FIG. 8 is a view of an exemplary embodiment of lamp operation according to a position of an external object in a pre-lamp operation step according to an exemplary embodiment of the present disclosure.

FIG. 9 is a view of an exemplary embodiment of lamp operation according to tracing of an external object in a pre-lamp operation step according to an exemplary embodiment of the present disclosure.

FIG. 10A and FIG. 10B are views of an exemplary embodiment of lamp operation according to tracing in a case where an external object moves in a front direction in a pre-lamp operation step according to an exemplary embodiment of the present disclosure.

FIG. 11A and FIG. 11B are flowcharts of overall lamp operation control after entering into an impact-based lamp operation mode.

It may be understood that the appended drawings are not necessarily to scale, presenting a somewhat simplified representation of various features illustrative of the basic principles of the present disclosure. The specific design features of the present disclosure as included herein, including, for example, specific dimensions, orientations, locations, and shapes will be determined in part by the particularly intended application and use environment.

In the figures, reference numbers refer to the same or equivalent parts of the present disclosure throughout the several figures of the drawing.

### DETAILED DESCRIPTION

Reference will now be made in detail to various embodiments of the present disclosure(s), examples of which are illustrated in the accompanying drawings and described below. While the present disclosure(s) will be described in conjunction with exemplary embodiments of the present disclosure, it will be understood that the present description is not intended to limit the present disclosure(s) to those exemplary embodiments of the present disclosure. On the other hand, the present disclosure(s) is/are intended to cover not only the exemplary embodiments of the present disclosure, but also various alternatives, modifications, equivalents and other embodiments, which may be included within the spirit and scope of the present disclosure as defined by the appended claims.

Because the present disclosure may be modified in various ways and may have various embodiments of the present disclosure, specific embodiments will be illustrated and described in the drawings. However, this is not intended to limit the present disclosure to specific embodiments, and it should be understood that the present disclosure includes all modifications, equivalents, and replacements included on the idea and technical scope of the present disclosure.

The suffixes “module” and “unit” used herein are used only for name distinction between elements and should not be construed as being physiochemically divided or separated or assumed that they may be divided or separated.

Terms including ordinals such as “first”, “second”, and the like may be used to describe various elements, but the elements are not limited by the terms. The terms are used only as name meaning for distinguishing one element from another element, and sequential meaning between the elements are understood not from the name but from the context of the description.

The term “and/or” is used to include any combination of a plurality of items to be included. For example, “A and/or B” includes all three cases such as “A”, “B”, and “A and B”.

When it is mentioned that an element is “connected” or “linked” to another element, it should be understood that the element may be directly connected or linked to another element, but another element may exist in between.

The terminology used herein is for describing specific exemplary embodiments only and is not intended to be limiting of the present disclosure. Singular expressions include plural expressions, unless the context clearly indicates otherwise. In the present application, it should be understood that the term “include” or “have” indicates that a feature, a number, a step, an operation, a component, a part, or a combination thereof described in the specification exists, but does not exclude the possibility of existence or addition of one or more other features, numbers, steps, operations, components, parts, or combinations thereof in advance.

Unless otherwise defined, all terms used herein, including technical or scientific terms, include the same meaning as that generally understood by those skilled in the art. It will be understood that terms, such as those defined in commonly used dictionaries, should be interpreted as including a meaning which is consistent with their meaning in the context of the relevant art and will not be interpreted in an idealized or overly formal sense unless so defined herein.

Furthermore, the term “unit”, “control unit”, “control device”, or “controller” is a term widely used for naming a controller that commands a specific function, and does not mean a generic function unit. For example, a control unit by these names may include a communication device that communicates with another controller or sensor to control a corresponding function, a computer-readable recording medium that stores an operating system or a logic command, input/output information, and the like, and one or more processors that perform judgement, calculation, determination, and the like necessary for controlling the corresponding function.

Meanwhile, the processor may include a semiconductor integrated circuit and/or electronic systems that perform at least one or more of comparison, judgement, calculation, and determination to achieve a programmed function. For example, the processor may be one of a computer, a microprocessor, a CPU, an ASIC, and an electronic circuit (circuitry, logic circuits), or a combination thereof.

The processor may be electrically connected to the memory, and the processor may retrieve and record data from the memory. The memory and the processor may be integrated or may be physically separated.

Hereinafter, each configuration will be described in detail in the exemplary embodiments of the present disclosure with reference to the accompanying drawings.

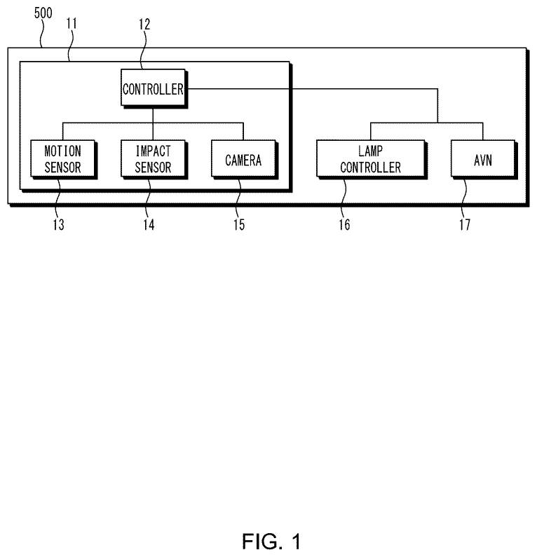

FIG. 1 is a view exemplarily illustrating a vehicle video recording device according to an exemplary embodiment of the present disclosure and a configuration of a vehicle including thereof.

Surely, each element illustrated in FIG. 1 illustrates only an element related to various exemplary embodiments of the present disclosure, and more elements may be included in a vehicle 500 and a vehicle video recording device 11. The vehicle video recording device 11 of the present disclosure is a built-in device, but is not limited thereto.

With reference to FIG. 1, the vehicle video recording device 11 according to an exemplary embodiment of the present disclosure includes a motion sensor 13 that detects movement of an external object in a surrounding of the vehicle 500, an impact sensor 14 that detects an impact of the external object on the vehicle, a camera 15 that records the surrounding of the vehicle 500, and a controller 12 that commands the camera 15 to start recording according to results of detecting of the motion sensor 13 and/or the impact sensor 14. Furthermore, there is a lamp controller 16 and an Audio, Video and Navigation (AVN) 17 connected to the controller 12 via communication.

The motion sensor 13 that detects movement of an external object in a surrounding the vehicle 500 may include, for example, at least one of a radio detection and ranging (Radar), a Light Detection and Ranging (LiDAR), ultrasonic waves, and an infrared sensor, and can detect a distance between the external object that shows movement at a front/rear/left/right side of the vehicle 500 and the vehicle. The motion sensor 13 may be integrated with a camera 15 module, or separately mounted in the vehicle 500. The motion sensor 13 may be applied only to the front side, may be applied to the front/rear side, or may be applied to the front/rear/left/right side thereof. The types of the sensor which may be included in the motion sensor 13 are not limited, and any sensor may be included as long as the sensor can detect motion of an external object of the vehicle 500. Furthermore, the motion sensor 13 may be provided exclusively in the vehicle video recording device 11, but a radar sensor for an advanced driver assistance system (ADAS) provided in the vehicle 500 and the like may be used.

The impact detecting sensor 15 that detects an external impact on the vehicle 500 may include an acceleration sensor or a gyro sensor, and can determine whether or not a collision occurs to the vehicle 500 and movement of the vehicle occurs. The types of the sensor which may be included in the impact detecting sensor 15 are not limited, and any sensor may be included as long as the sensor can detect an impact of the external object on the vehicle 500. Furthermore, the impact detecting sensor 15 may be provided exclusively for the vehicle video recording device 11, and an acceleration sensor for other use provided in the vehicle 500 and the like may be used.

The camera 15 includes a front camera and a rear camera in an exemplary embodiment of the present disclosure, but is not limited thereto. The front camera is provided to capture a front area of the vehicle 500, and the rear camera is provided to capture a rear area of the vehicle 500.

For example, the front camera may be provided in a window shield in the vicinity of a rear view mirror in a vehicle cabin of the vehicle 500, and the rear camera may be provided in a rear window or a rear bumper of the vehicle cabin of the vehicle 500.

The front camera and the rear camera can support any one image quality of HD, FHD, and Quad HD, for example. The front camera and the rear camera do not necessarily have the same image quality, and a camera for ADAS of the vehicle 500 may be used.

Furthermore, the camera 15 has an aperture value of F2.0 or less, and has an aperture value of F1.6 or less. As the aperture value is lowered, the more light is collected, and thus recording may be conducted brightly. Furthermore, as an image tuning technology is applied, noise and light loss are minimized, and thus clear recording may be conducted even in a dark environment.

The controller 12 can implement a regular recording during traveling and a regular recording in a parked state by controlling other elements, and when an impact is predicted or it is determined that an impact has been sensed according to a detecting signal of the motion sensor 13 and the impact sensor 14, the controller 12 can transmit a command to the lamp controller 16 to operate a lamp and can command the camera 15 to start recording. Furthermore, a user can input a predetermined value for a condition of preparing and implementing recording start using a user menu via the AVN 17.

The lamp controller 16 is configured to control a lamp as the controller 12 inputs a lamp control signal. The lamp control signal includes information on a position and a lighting maintaining time of the lamp necessary for lighting the lamp. Embodiments of the lamp operating in the vehicle 500 may include a plurality of lamps in a headlamp module, a front fog lamp, a turn signal lamp, a plurality of lamps in an outsider mirror, a rear fog lamp, a tail lamp, a plurality of lamps in the interior, and the like, and at least one of the lamps may be determined according to the position information. The position information may be information on a front side, a rear side, a lateral side, an interior of the vehicle, for example, or may be identification information that directly indicates the lamps.

Meanwhile, generally various controllers are required to control these lamps, and there is a case where a method for controlling a lamp of each controller varies by the system of the vehicle. In an exemplary embodiment of the present disclosure, these controllers are collectively referred to as lamp controller 16. The lamp controller 16 transmits a lighting signal to the lamp when receiving a lamp control signal from the controller 12 while having a wired or wireless communication with the lamp. At this time, in a case of wired connection to the lamp, it is desirable that the lamp controller 16 is connected to a line extended from the lamp with a connector.

The AVN 15 is connected via communication through a vehicle controller or directly to the controller 12, and a scene of the AVN 17 is configured as a user interface for selection of various setting parameters of the vehicle video recording device 11 by a user.

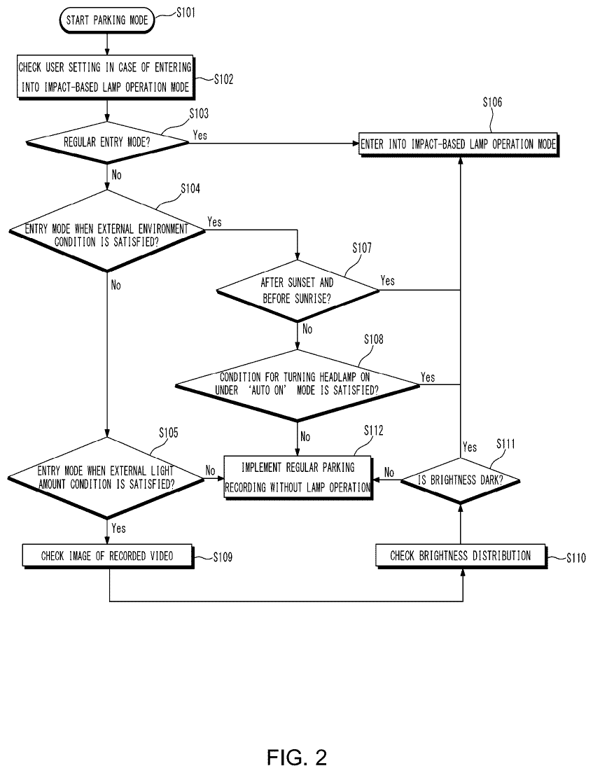

FIG. 2 illustrates a process of entering into the impact-based lamp operation mode in a case where a parking mode of the vehicle video recording device according to an exemplary embodiment of the present disclosure starts.

With reference to FIG. 2, when the parking mode of the vehicle video recording device starts (S101), and enters into the impact-based lamp operation mode, at least one of three modes may be determined according to the user setting such as a user setting mode (USM) (S102). Among the three modes, the first one is a regular entry mode of always entering into an impact-based lamp operation mode (S103), the second one is a mode of entering into an impact-based lamp operation mode in a case where a set external environmental condition is satisfied (S104), and the third one is a mode of entering into an impact-based lamp operation mode in a case where a set external light amount condition is satisfied (S105).

In a step of selecting at least one of the three modes (S102), it is checked whether or not the mode is a regular entry mode (S103), when the mode is the regular entry mode (YES of S103), the mode enters into an impact-based lamp operation mode (S106), and when the mode is not the regular entry mode (NO of S103), it is checked whether or not the mode is a mode of entering into an impact-based lamp operation mode in a case where the set external environmental condition is satisfied (S104).

When the mode is a mode of entering into an impact-based lamp operation mode in a case where the set external environmental condition is satisfied (YES of S104), it is checked whether or not a time when the parking mode of the vehicle is a time between sunset and sunrise (S107), when the condition is satisfied (YES of S107), the mode enters into an impact-based lamp operation mode (S106), and when the condition is not satisfied (NO of S107), it is checked whether or not it is a condition under which a headlamp is turned AUTO ON (S108). When the condition under which a headlamp is turned AUTO ON is satisfied (YES of S108), the mode enters into an impact-based lamp operation mode (S106), and when the condition is not satisfied (NO of S108), general parking recording without lamp operation is conducted (S112).

When the mode is not the mode of entering into an impact-based lamp operation mode in a case where a set external environmental condition is satisfied (NO of S104), it is checked whether or not the mode is a mode of entering into an impact-based lamp operation mode in a case where a set external light amount condition is satisfied (S105).

When the mode is the mode of entering into an impact-based lamp operation mode in a case where a set external light amount condition is satisfied (YES of S105), an image obtained from the recorded video is checked (S109), brightness and distribution of pixels are analyzed (S110), and it is checked whether or not brightness distribution standard is in a dark state based on the analyzed data (S111). When the brightness distribution standard is in a dark state (YES of S111), the mode enters into an impact-based lamp operation mode (S106), and when the brightness distribution standard is not in a dark state (NO of S111), general parking recording without lamp operation is conducted (S112).

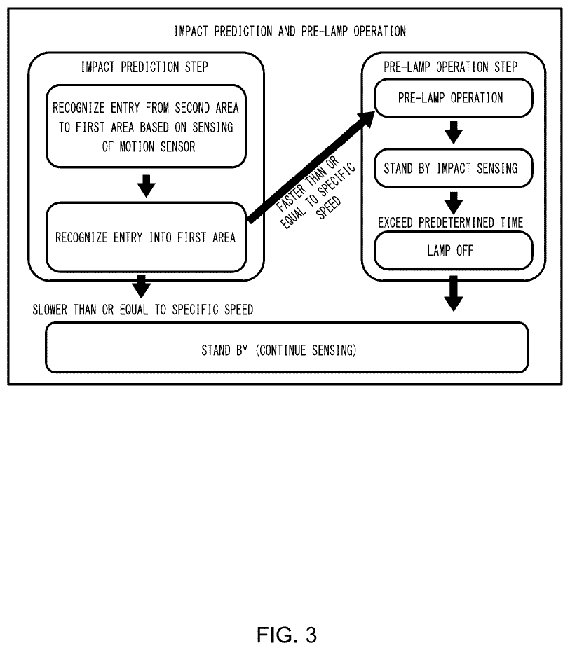

FIG. 3 is a view exemplarily illustrating impact prediction and pre-lamp operation according to an exemplary embodiment of the present disclosure.

With reference to FIG. 3, after entering into the impact-based lamp operation mode, in a case where it is determined that an impact of the external object on the vehicle is predicted, lamp may be operated in advance to generate a light source, and this may be described in two steps. The two steps are a pre-impact prediction step and a pre-lamp operation step.

In the pre-impact prediction step, when an external object is sensed by the motion sensor 13, the area is divided into a general detecting area which is comparatively far from the vehicle and a danger area which is close to the vehicle. In an exemplary embodiment of the present disclosure, the general detecting area which is comparatively far from the vehicle is referred to as a second area, and the danger area which is close to the vehicle is referred to as a first area. It may be predicted that when the external object sensed by the motion sensor 13 is sensed only in the second area, the lamp is not operated, and when the external object moves from the second area to the first area at a speed equal to or faster than a set speed, an impact may be given. When the impact is predicted, the pre-lamp operation step is proceeded.

In the pre-lamp operation step, a speed of the external object is determined and the lamp is turned ON right before a time when the external object arrives at the first area. After that, when there is no impact is provided to the vehicle by the set time, the lamp turned ON is turned OFF again.

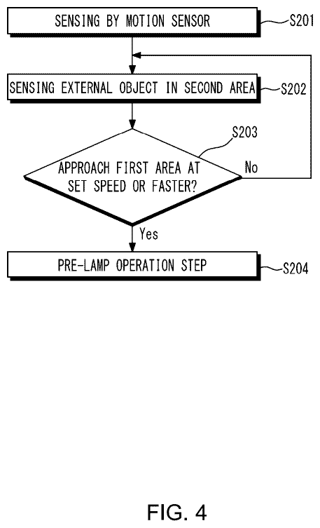

FIG. 4 is a flowchart of pre-impact prediction steps according to an exemplary embodiment of the present disclosure.

With reference to FIG. 4, the presence or absence of the pre-lamp operation is determined based on information sensed by the motion sensor 13 (S201). First, when an external object approaches the second area which is a general detecting area, the motion sensor 13 continuously maintains detecting of the external object (S202). It is checked whether or not the external object is sensed in the second area, and the external object approaches the first area from the second area at a speed equal to or faster than a set speed (S203). In a case where the moving external object does not approach the first area from the second area at a speed equal to or faster than a set speed, that is, stays only in the second area, the lamp is not turned ON (NO of S203), and the motion sensor 13 continues detecting. When the external object approaches the first area at a speed equal to or faster than a set speed (YES of S203), the mode enters into a pre-lamp operation step (S204). The speed of the external object entering may be determined by checking a distance of movement per hour.

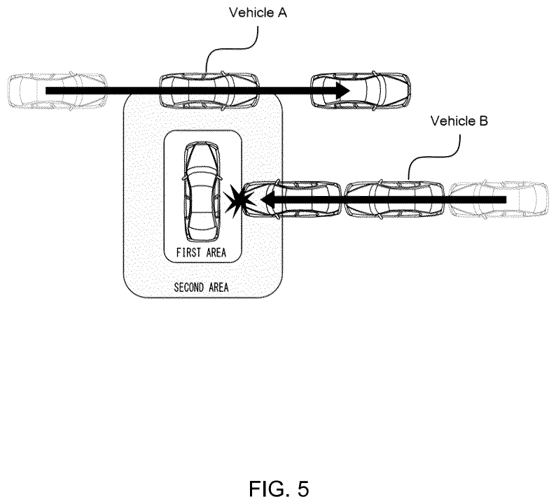

FIG. 5 is a view of a lamp operation depending on the distinction of the motion sensor detecting area according to an exemplary embodiment of the present disclosure.

With reference to FIG. 5, the detecting area of the motion sensor 13 may be divided into a first area and a second area. As described above, the general detecting area is referred to as a second area, and the danger area is referred to as a first area. The first area may be defined as an area which is very close to the vehicle, and is at a distance at which the external object can give a direct impact. The second area may be defined as an area that is close to the vehicle in a maximum range in which the motion sensor 13 can implement detecting, that is, an outermost range of the first area. The range of the first area and the second area may be changed and set by a user.

When describing the lamp operation depending on the distinction of the motion detector detecting area as an exemplary embodiment of the present disclosure, in a case where the external object, e.g., the vehicle an in FIG. 5, passes through only the second area, it is determined that the external object cannot give an impact of the external object on the vehicle and a command to operate the lamp is not transmitted, and in a case where the external object, e.g., the vehicle B in FIG. 5, passes through the second area and approaches the first area, a speed of the approaching external object is determined, and when the speed is equal to or faster than a set speed, a command to operate the lamp is transmitted. The motion sensor 13 can continuously recognize the external object, and detect a change in the gap between the external vehicle and the vehicle, and thus the speed may be determined based on the position information depending on time. By setting the speed, it is possible to prevent excessive consumption of power of the vehicle due to excessive LAMP operation.

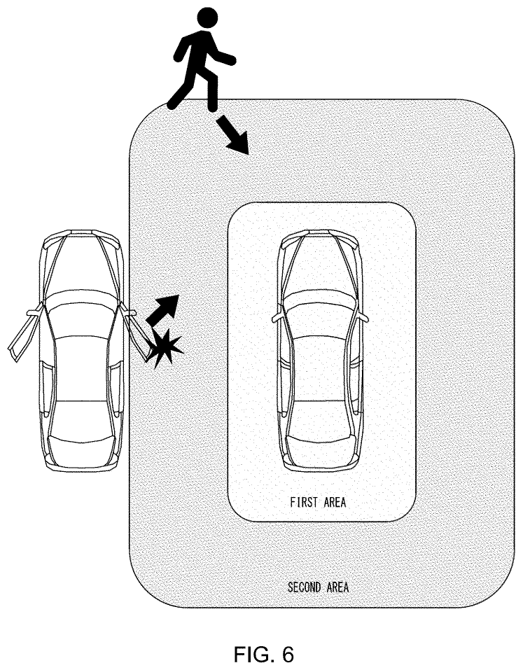

FIG. 6 is a view of standard of speed setting of an external object at a time of pre-impact prediction according to an exemplary embodiment of the present disclosure.

With reference to FIG. 6, the speed setting standard may be divided into a case at the front/rear side of the vehicle and a case at the lateral side of the vehicle. In the case of the front/rear side of the vehicle, there are many cases where a person frequently moves, and thus there is a need that a speed of a person walking is sensed so that the lamp is not operated. Therefore, at a speed equal to or slower than the speed of a person running, the lamp should be turned OFF, and at a speed equal to or faster than the speed of a person running, the lamp should be turned ON. As an exemplary embodiment of the present disclosure, the speed standard in a case of the front/rear side may be about 6 km/h, and the value may be modified by various tests such as principle test. In the case of the lateral side of the vehicle, there occur many cases where an impact due to door opening of other vehicles is caused in an actual situation, and thus pre-impact prediction is conducted in a case where the speed is equal to or faster than the speed of opening a door of a vehicle next to a driver's vehicle, which can harm the driver's vehicle.

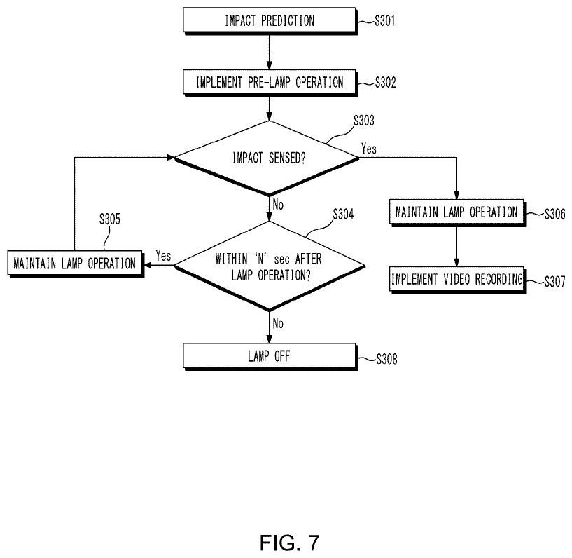

FIG. 7 is a flowchart of pre-lamp operation steps according to an exemplary embodiment of the present disclosure.

With reference to FIG. 7, impact is predicted in the pre-impact prediction step (S301), and when the pre-lamp operation step is conducted, lamp operation is conducted because the impact has been predicted (S302).

It is checked whether or not the impact has been provided after the lamp operation (S303), when the impact is sensed (YES of S303), the impact recording video generation is conducted (S307) while maintaining the lamp operation (S306), and when the impact has not been sensed (NO of S303), it is checked whether or not the time is within a set time after the lamp operation (S304). When the time is within a set time after the lamp operation (YES of S304), the lamp operation is maintained (S305). When the impact is provided within a specific time while maintaining the lamp operation (YES of S303), the step enters into video recording in a state of maintaining the lamp operation (S306) (S307), and when the time is not within a set time after the lamp operation (NO of S304), that is, when the set time passes after the lamp operation, the lamp is turned OFF (S308).

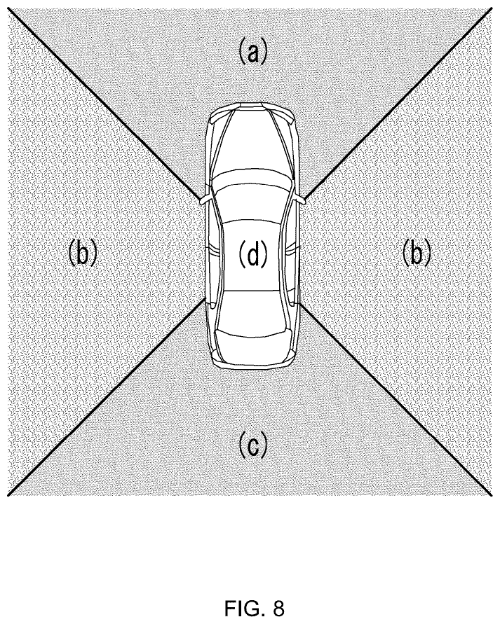

FIG. 8 is a view of an exemplary embodiment of lamp operation according to a position of an external object in the pre-lamp operation step according to an exemplary embodiment of the present disclosure.

With reference to FIG. 8, the lamp operation may be divided into four lamp operations depending on the position of the external object which is predicted to give an impact or has provided an impact. The positions are divided into a front side (a), a lateral side (b), a rear side (c), and an interior (d) where operation is conducted in accordance with the impact detecting results. The front side (a) is a case where movement is sensed on the front side, and a lamp control signal is output to a plurality of lamps in a headlamp module and a front fog lamp, in the case of lateral side (b), a lamp control signal is output to a turn signal lamp and a plurality of lamps in an outsider mirror, in the case of rear side (c), a lamp control signal is output to a rear fog lamp and a tail lamp, and in the case where movement of the external object that has provided an impact is also sensed in the interior (d) of the vehicle, it may be included that a lamp control signal is output to a plurality of lamps in the interior of the vehicle. When detecting the movement in the interior, rear occupant alert (ROA) and the like may be used.

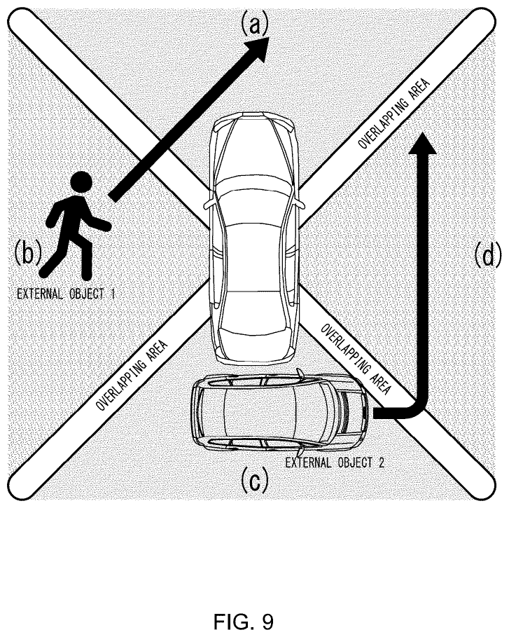

FIG. 9 is a view of an exemplary embodiment of lamp operation according to tracing of an external object in a pre-lamp operation step according to an exemplary embodiment of the present disclosure.

With reference to FIG. 9, in a case where an external object that has provided an impact moves, it is possible to operate a lamp corresponding to the position in accordance with the movement path. In a case where the moving external object is sensed at a portion where the front/rear side lamp lighting area overlaps with the lateral side lamp lighting area, it is possible to operate lamps on the front/lateral side or the rear/lateral side simultaneously. As an exemplary embodiment of the present disclosure, when an external object 1 gives an impact of the external object on the vehicle and then moves in an arrow direction, the lamp controller can operate a lamp for lighting the area (b) initially. After that, when the external object 1 passes through the overlapping area between (a) and (b), lamps in the two areas are operated, and when a person exists only in the area (a), a lamp for lighting the area (a) is operated. In a case where the external object 1 gives an impact of the external object on the vehicle and then enters the interior of the vehicle, the external object 1 receives a rear occupant alert (ROA) signal and operates the internal lamp. In a case of an external object 2, the vehicle is positioned in the overlapping area initially, and thus the area of lighting the lamp may be proceeded in an command of (c) and (d)→(d)→(d) and (a)→(a).

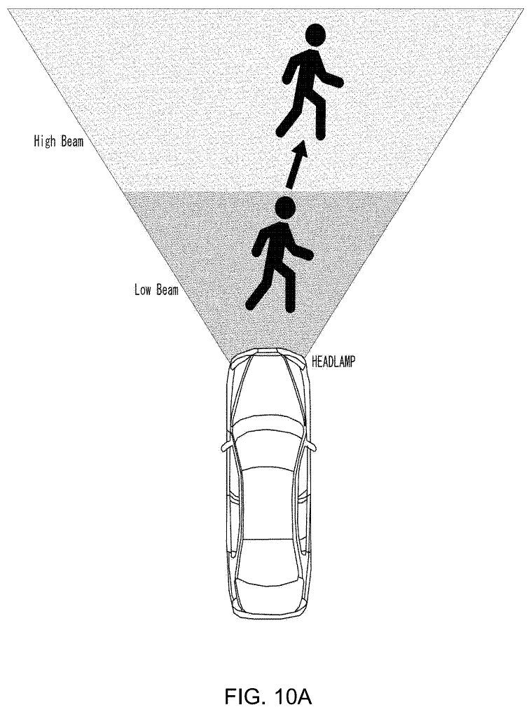

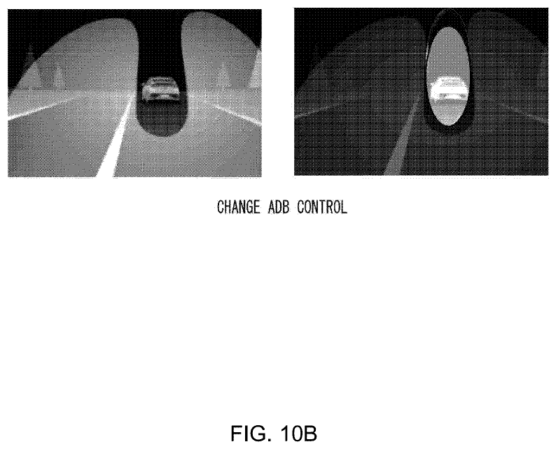

FIG. 10A and FIG. 10B are views of an exemplary embodiment of lamp operation according to tracing in a case where an external object moves in a front direction in a pre-lamp operation step according to an exemplary embodiment of the present disclosure.

With reference to FIG. 10A, in a case of a headlamp and/or high beam assist (HBA), and an adaptive front lighting system (AFLS), when the external object moves in the front direction, the lamp operation varies by the position of the external object. As an exemplary embodiment of the present disclosure, when a subject is in a short-range area, a low beam lamp is operated and when a subject moves in a long-range area, high beam is operated. When using such a function, it is possible to accurately record the movement of the external object continuously.

In the case of the adaptive driving beam (ADB), as shown in FIG. 10B the original function of ADB is to emit light of the lamp to a different background other than the external object on the front side not to cause glare to the external object on the front side of the vehicle 500. However, in a case of using the impact-based lamp operation function, it is notified to the ADB that it is a state of parking impact recording in which the impact-based lamp operation function is used so that the ADB emits light to only an external object that operates contrary to the original function, and thereby it is possible to accurately record the external object that gives an impact and then moves.

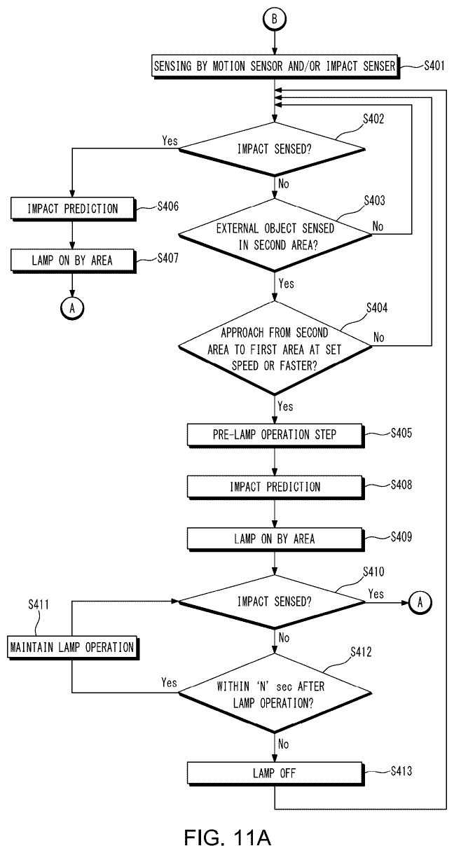

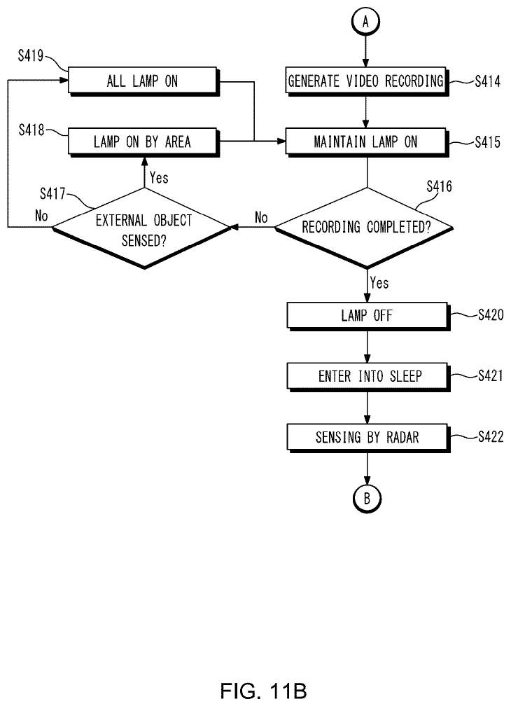

FIG. 11A and FIG. 11B are flowcharts of overall lamp operation control after entering into an impact-based lamp operation mode.

With reference to FIG. 11, the presence or absence of the pre-lamp operation is determined based on information sensed from the motion sensor 13 and/or the impact sensor 14.

It is determined whether or not an impact of the external object on the vehicle is sensed (S402). When it is determined that the impact on the vehicle has not been sensed (NO of S402), it is determined whether or not the motion sensor 13 has sensed an external object in the second area (S403), when it is determined that the external object has been sensed in the second area (YES of S403), it is checked whether or not the external object approaches the first area from the second area at a speed equal to or faster than a set speed (S404), and when it is determined that the external object approaches at a speed equal to or faster than a set speed (YES of S404), it is determined that impact prediction has been conducted and the mode enters into a pre-lamp operation step (S405).

The mode entering into a pre-lamp operation step means that an impact has been predicted (S408), and a lamp operation signal is output to only a lamp corresponding to a position at which the external object is sensed and the lamp is turned ON (S409). After that, it is checked whether or not an actual impact occurs (S410), and when the actual impact has occurred (YES of S410), a video recording starts (S414), when the actual impact has not occurred (NO of S410), it is checked whether or not the time is within a set time after lamp operation (S412), and when it is checked that the time is within a set time after lamp operation (YES of S412), the lamp operation is maintained (S411). When an impact is provided within a specific time while maintaining the lamp operation (YES of S410), the mode enters into video recording (S414), and when the time is not within a set time after the lamp operation (NO of S412), that is, when a set time passes after the lamp operation, the lamp is turned OFF (S413).

When the video recording starts (S414), the lamp is maintained to be ON while implementing recording (S415), and it is checked whether or not the recording is completed (S416). When the recording is continuously conducted (NO of S416), it is checked whether or not the motion sensor 13 detects the external object while implementing recording. (S417). When the external object is sensed (YES of S417), a lamp operation signal is output to a lamp corresponding to the position at which the external object has been detected, and the lamp is turned ON (S418) and the lamp is maintained to be ON (S415). It is checked whether or not recording is completed (S416), when it is determined that the recording has been completed (YES of S416), the lamp is turned OFF (S420), and the lamp controller 16 and the like enter into a SLEEP mode (S421) and then the motion sensor and the impact sensor implementing detecting again (S422). However, when the external object is not sensed (NO of S417), all lamps are turned ON (S419) and maintained to be ON (S415).

In a case of determining whether or not the impact on the vehicle is sensed (S402), when it is determined that the impact on the vehicle has been sensed (YES of S402, S406), all lamps are turned ON (S407), and video recording starts (S414). When the video recording starts (S414), the lamp is maintained to be ON while implementing the recording (S415), and it is checked whether or not the recording is completed (S416). When the recording is continuously conducted (NO of S416), it is checked whether or not the motion sensor 13 detects an external object while implementing the recording (S417). When the external object is sensed (YES of S417), a lamp operation signal is output to only a lamp corresponding to a position at which the external object has been detected, and the lamp is turned ON (S418) and the lamp is maintained to be ON (S415). It is checked whether or not the recording is completed (S416), and when it is determined that the recording has been completed (YES of S416), the lamp is turned OFF (S420), the lamp controller 16 and the like enter into a SLEEP mode, and then the motion sensor and the impact sensor implementing detecting (S422). However, when the external object is not sensed (NO of S417), all lamps are turned ON (S419) and maintained to be ON (S415).

It is obvious for those skilled in the art that the present disclosure can be specified in other specific forms without departing from the gist or essential features of the present disclosure. Therefore, the above-mentioned detailed description should be considered not to be limited but exemplary in every aspect. The scope of the present disclosure should be determined by reasonable interpretation of the attached claims, and all modifications within the equivalent range of the present disclosure are included in the scope of the present disclosure.

The method according to the above-described embodiments may be produced as a program which is to be implemented in a computer, the present program can be stored in a computer-readable recording medium, and embodiments of the computer-readable recording medium include ROM, RAM, CD-ROM, a magnetic tape, a floppy disk, an optical data storage device, and the like, and also include those in a form of a carrier wave (for example, transmission via Internet).

The computer-readable recording medium can be distributed in a computer system connected via a network, and a computer-readable code can be stored and implemented by a distribution method. Furthermore, function programs, codes, and code segments to realize the above-described method can be easily inferred by programmers in the field of the present disclosure under which the embodiments fall.

It is obvious for those skilled in the art that the present disclosure can be specified in other specific forms without departing from the gist or essential features of the present disclosure.

The foregoing descriptions of specific exemplary embodiments of the present disclosure have been presented for purposes of illustration and description. They are not intended to be exhaustive or to limit the present disclosure to the precise forms disclosed, and obviously many modifications and variations are possible in light of the above teachings. The exemplary embodiments were chosen and described to explain certain principles of the present disclosure and their practical application, to enable others skilled in the art to make and utilize various exemplary embodiments of the present disclosure, as well as various alternatives and modifications thereof. It is intended that the scope of the present disclosure be defined by the Claims appended hereto and their equivalents.

What is claimed is:

1. A video recording apparatus for a vehicle, the apparatus comprising:
a motion sensor configured to sense movement of an external object outside the vehicle;
an impact sensor configured to detect an impact on the vehicle;
a lamp controller configured to control a lamp of the vehicle; and
a controller operatively connected to the motion sensor, the impact sensor and the lamp controller and including a memory storing computer-readable instructions and one or more processors configured to execute the computer-readable instructions,
wherein the computer-readable instructions executed by the one or more processors, cause the controller to determine that the impact is predicted or has been sensed based on information from at least one of the motion sensor or the impact sensor, and transmit a first command to the lamp controller for operating the lamp and a second command to the camera for recording a video.

2. The video recording apparatus of claim 1,
wherein the computer-readable instructions further cause the controller to determine that a parking mode is activated and transmit a command to the lamp controller to set an option for entering into an impact-based lamp operation mode, and
wherein the option for entering into the impact-based lamp operation mode includes at least one of a regular entry for entering into the impact-based lamp operation mode whenever the parking mode is activated, an environment-based entry for entering into the impact-based lamp operation mode based on that a set external environmental condition is satisfied, or a light-based entry for entering into the impact-based lamp operation mode based on that a set external light amount condition is satisfied.

3. The video recording apparatus of claim 2, wherein the environment-based entry includes entering into the impact-based lamp operation mode based on a determination of whether or not a time when the parking mode of the vehicle is activated is between a sunset time and a sunrise time, or whether or not a condition under which a headlamp of the vehicle is turned by AUTO-ON setting is satisfied.

4. The video recording apparatus of claim 2, wherein the light-based entry includes entering into the impact-based lamp operation mode based on information on brightness of the recorded video.

5. The video recording apparatus of claim 1, wherein the computer-readable instructions further cause the controller to determine that the impact is predicted based on the external object being predicted to enter into a first area from a second area at a speed faster than or equal to a set speed.

6. The video recording apparatus of claim 5, wherein the set speed includes a first speed for a front side or a rear side of the vehicle and a second speed for a lateral side of the vehicle.

7. The video recording apparatus of claim 1, wherein the computer-readable instructions further cause the controller to transmit a command to the lamp controller to output a lamp control signal to a lamp of the vehicle located correspondingly to a position or a direction of the impact.

8. The video recording apparatus of claim 7, wherein the lamp control signal includes:
a first lamp control signal associated with a headlamp module or a front fog lamp based on the position or the direction of the impact being a front side of the vehicle;
a second lamp control signal associated with a turn signal lamp or a lamp in an outsider mirror based on the position or the direction of the impact being a lateral side of the vehicle;
a third lamp control signal associated with a rear fog lamp or a tail lamp based on the position or the direction of the impact being a rear side of the vehicle; or
a fourth lamp control signal associated with a lamp in an interior of the vehicle based on the movement of the external object being sensed in the interior of the vehicle.

9. The video recording apparatus of claim 1,
wherein the lamp is in plural,
wherein the computer-readable instructions further cause the controller to command the lamp controller to output a lamp control signal based on a movement path of the external object after the impact, and
wherein the lamp control signal includes respective lamp control signals to a plurality of lamps corresponding to an overlapping area.

10. The video recording apparatus of claim 1,
wherein based on the external object being sensed to move in a front direction after the impact, the computer-readable instructions further cause the controller to transmit a command to the lamp controller to control a headlamp and/or HBA/AFLS based on a position of the external object.

11. The video recording apparatus of claim 1,
wherein the computer-readable instructions further cause the controller to transmit a command to the lamp controller to control the lamp to emit light on the external object that has provided the impact by use of an adaptive driving beam (ADB) control.

12. A method for controlling a video recording apparatus of a vehicle, the method comprising:
starting, by a controller, a parking mode of the video recording apparatus;
detecting, by a motion sensor operatively connected to the controller, movement of an external object outside the vehicle;
detecting, by an impact sensor operatively connected to the controller, an impact on the vehicle; and
transmitting, by the controller, a command to a lamp controller to operate a lamp based on the impact being predicted or sensed based on information on the movement or the impact of the external object.

13. The method of claim 12,
wherein the starting of the parking mode includes setting an option for entering into an impact-based lamp operation mode, and
wherein the setting of the option includes at least one of a regular entry for entering into the impact-based lamp operation mode based on whenever the parking mode is activated, an environment-based entry for entering into the impact-based lamp operation mode based on that a set external environmental condition is satisfied, or a light-based entry for entering into the impact-based lamp operation mode based on that a set external light amount condition is satisfied.

14. The method of claim 13, wherein the environment-based entry includes entering into the impact-based lamp operation mode based on a determination of whether or not a time when the parking mode of the vehicle is activated is between a sunset time and a sunrise time, or whether or not a condition under which a headlamp of the vehicle is turned by AUTO-ON setting is satisfied.

15. The method of claim 13, wherein the light-based entry includes entering into the impact-based lamp operation mode based on information on brightness of a recorded video.

16. The method of claim 12, further comprising determining that the impact is predicted by determining that the external object is predicted to enter into a first area from a second area at a speed faster than or equal to a set speed.

17. The method of claim 16, wherein the set speed includes a first speed for a front side or a rear side of the vehicle and a second speed for a lateral side of the vehicle.

18. The method of claim 12, wherein the transmitting of the command to the lamp controller includes transmitting a command to the lamp controller to output a lamp control signal to a lamp of the vehicle located correspondingly to a position or a direction of the impact.

19. The method of claim 18, wherein the lamp control signal includes:
a first lamp control signal associated with a headlamp module or a front fog lamp based on the position or the direction of the impact being a front side of the vehicle;
a second lamp control signal associated with a turn signal lamp or a lamp in an outsider mirror based on the position or the direction of the impact being a lateral side;
a third lamp control signal associated with a rear fog lamp or a tail lamp based on the position or the direction of the impact being a rear side of the vehicle; or
a fourth lamp control signal associated with a lamp in an interior of the vehicle based on the movement of the external object being sensed in the interior of the vehicle.

20. The method of claim 12,
wherein the lamp is in plural,
wherein the transmitting of the command to the lamp controller includes transmitting a command to output a lamp control signal based on a movement path of the external object after the impact, and
wherein the lamp control signal includes respective lamp control signals to the plurality of lamps corresponding to an overlapping area.
